(19) United States
(12) Patent Application Publication
(10) Pub. No.: US 2001/0042985 A1
(43) Pub. Date: Nov. 22, 2001

(54) Modified tailgate

(76) Inventor: William O. Hodge, Theodore, AL (US)

Correspondence Address: GREGORY M. FRIEDLANDER & ASSOCIATES, P.C., 11 SOUTH FLORIDA STREET, MOBILE, AL, 36606-1934, US

(21) Appl. No.: 09/840,319

(22) Filed: Apr. 23, 2001

Related U.S. Application Data
(60) Provisional application No. 60/089,797, filed on Jun. 18, 1998.

(51) Int. Cl. B62D 33/03

(52) U.S. Cl. 296/26.08

(57) ABSTRACT

A panel or cutting table which is preferably substituted for the tailgate for holding a cuttable item to be worked on and for mounting a tool having a blade and for supporting a cuttable item said device being attachable to a vehicle resting on the ground with an extendable central frame which may be reduced in size to be approximately the size of the panel or tailgate replaced and defining a holding mechanism for holding a saw and other tools so that the tools may be rotated to give the proper cut and also having an aligning rule to control the angle of the blade relative to a second aligning rule which holds the item to be cut square. In addition, the panel has a pair of legs capable of receiving two by fours so that a saw horse is provided. Finally, a scaffolding framework is described so that the panel may be used on hot days with a covering.

### PRIORITY STATEMENT

This patent is a continuation in part of provisional application Ser. No. 60/089,797 filed Jun. 18, 1998; utility Pat. No. 09/041,070 filed Mar. 10, 1998 and utility Pat. No. 09/304,184 filed May 3, 1999.

### BACKGROUND OF THE INVENTION

The present invention related to a saw horse type cutting surface. More particularly, the present invention relates to a cutting surface mountable to a vertical surface.

1. Prior Art

| PATENT NO. | TITLE | INVENTOR | DATE |
|---|---|---|---|
| 5,090,335 | TABLE FOR TRUCK BED | Kenneth R. | 02/25/92 |
| | | Russell | |
| 4,951,991 | TELESCOPING TRUCK | Dale C. | 08/28/90 |
| | BED EXTENSION | Haigler | |
| 4,705,254 | ADJUSTABLE AND | Mark G. | 11/10/87 |
| | REMOVABLE VICE | Swanson | |
| | STAND ASSEMBLY FOR | | |
| | MOTOR VEHICLES | | |
| 4,029,245 | AUTOMOBILE MATERIAL | David L. | 06/14/77 |
| | CARRIER | Berlin | |
| 1,756,629 | EXTENDIBLE VISE | A. W. | 04/29/30 |
| | SUPPORT | Campbell | |
| 5-319164 | (JAPAN) WORKING | Akihiro | 12/03/93 |
| | VEHICLE MOUNTED | Murakami | |
| | WITH LONG ARTICLE | | |
| | WORKING | | |
| 1-282040 | (JAPAN) RECEIVING | Ryosuke | 11/13/89 |
| | TABLE DEVICE FOR | Okawa | |
| | VEHICLE | | |
| 2,468,579 | EXTENSIBLE LOAD- | H. Vuori | 04/26/49 |
| | SUPPORTING MEANS FOR | | |
| | TRUCKS | | |
| 5,451,088 | COMBINATION FRAME- | Robert L. | 09/19/95 |
| | SUPPORT BOX | Broad | |
| | RECEIVING & SELF- | | |
| | STABILIZING BED EXT. | | |
| 5,433,566 | TAILGATE-MOUNTED | Douglas B. | 07/18/95 |
| | STABILIZING APPARATUS | Bradley | |
| 5,267,748 | VEHICLE TOOL | Charles F. | 12/07/93 |
| | PLATFORM APPARATUS | Curran | |
| | AND METHOD | | |
| 5,533,771 | MULTIPLE PURPOSE | Shepard | 07/09/96 |
| | TRUCK TAILGATE | Taylor; | |
| | APPARATUS | Seabrook | |
| | | Taylor | |
| 5,458,389 | DEVICE FOR EXTENDING | Freddie W. | 10/17/95 |
| | THE BED OF A | Young | |
| | TRANSPORT VEHICLE | | |
| 5,575,521 | TAILGATE BOX, TABLE, | Gregory D. | 11/19/96 |
| | AND SINK | Speis | |
| 4,846,385 | LOCKABLE MOUNTING | William W. | 07/11/89 |
| | BRACKET FOR CHAIN | Frantus | |
| | SAWS | | |
| 4,727,777 | VEHICLE-MOUNTED | John Obester | 03/01/88 |
| | SUPPORT FOR | | |
| | SHARPENING CHAIN | | |
| | SAWS | | |
| 5,007,568 | TRUCK SIDEWALL | Jimmy C. Da | 04/16/91 |
| | MOUNTED CHAIN SAW | Vault | |
| | CARRIER | | |
| 5,010,978 | APPARATUS AND | Scott A. | 04/30/91 |
| | METHOD FOR A SAWING | Jimmerson | |
| | STAND | | |
| 5,490,649 | DEVISE FOR MOUNTING, | Louis N. | 02/13/96 |
| | SECURING AND | Kusalich | |
| | SUPPORTING PORTABLE | | |
| | POWER TOOLS HAVING | | |
| | BED EXTENSION | | |
| | ASSEMBLIES | | |
| 5,267,748 | VEHICLE TOOL | Charles F. | 12/07/93 |
| | PLATFORM APPARATUS | Curran | |
| | AND METHOD | | |
| 4,025,014 | STORAGE HOOK | Charles O. | 05/24/77 |
| | | Larson | |
| 2,291,381 | DISPLAY FIXTURE | C. E. Drake | 03/03/41 |
| 1,593,722 | FASTENING DEVICE FOR | B. P. Joyce | 07/27/26 |
| | GUN TOOLS | | |

2. Related Art

The prior art as exemplified by the other patents show various platforms which can be mounted to the flat bed of a truck, as well as certain saw holders which are shown mounted either to the bumper or in the bed of a truck for holding saws.

None of these prior art references provide for a work surface similar to that provided by two spaced sawhorses. Nor does the prior art suggest a saw horse which can sit onto or over the raised sides, tail gate or rear panel of a flat bed truck. The key elements are a pair of cutting surfaces, each of which cutting surfaces having an exposed end, and a bracket for holding the cutting surface so that the exposed ends are held parallel for cutting. An additional improvement is to use, as at least one anchor for at least one bracket as being the tailgate of a truck.

A saw horse type cutting surface is a surface which comprises at least two lengths of cut material (cuttable material such as wood) spaced at a desired distance, each being on approximately the same level from the ground level on which a piece of work (such as a length of wood) may be placed for cutting.

The prior art shows several surfaces attachable to the rear of a vehicle. The present invention differs from those in that they do not provide a holder for a cutting surface, and in most cases, do not contain parallel cutting surfaces so that they may be used in the same manner as a conventional saw horse.

The present invention provides a way for providing a transportable saw horse, which may be attached to a vehicle, and preferably the tail gate of a vehicle. Other art, such as U.S. Pat. No., 5,267,748, utilizes the rear tail gate hitch having a single tool platform to which a work tool may be secured. The inventive concept embodied in the prior art deals with various types of tables and related structures.

The prior art does not describe two parallel cutting surfaces supported by a vehicle for use as cutting surfaces.

### GENERAL DESCRIPTION OF THE PREFERRED EMBODIMENT

A portable version of the preferred embodiment comprises a saw horse type cutting surface as described above held to a vertical surface, such as the side or tailgate of a truck by a mounting means. In this embodiment, the mounting means has a bracket engaging on its inner surface, possibly, with padding along an internal surface, which can fit over or onto the vertical surface and tighten in place. The mounting means or support provides a surface for mounting a bracket means or beam which may be made in part, of cut material (primarily wood) or may receive a cut surface made of cut material. The cut material, such as a wooden two-by-four, provides a saw horse-type cutting surface when two of these elements are in place.

Hence, in the preferred embodiment, there are two mounting means supporting two brackets holding two cut surfaces. In this way two saw horses are provided.

It is therefore an object of this invention, to provide for a portable saw horse which may be utilized wherever a raised wall is present.

It is further the object of this invention to provide a saw horse which may be mounted on the tailgate, receiving hitch or side of a pick-up truck.

It is further the object of this invention to provide a sturdy, stable surface for cutting in a variety of environments.

It is further the object to provide a portable surface which can be utilized as a mounting for a table, shade, scaffolding, table saw, drill or for other purposes consistent with the disclosure set out herein.

These and other objects and improvements of the invention will become more clear from the detailed description of the preferred embodiment set forth below, as well as the figures, in which like parts have similar numbers.

### BRIEF DESCRIPTION OF THE DRAWINGS

For a further understanding of the nature and objects of the present invention, reference should be made to the following detailed description taken in conjunction with the accompanying drawings in which like parts are given like reference numerals and wherein:

FIG. 1 is an embodiment showing the preferred embodiment in place over a truck tailgate.

FIG. 2 is a rear view of the embodiment shown in FIG. 1.

FIG. 3 is an alternate embodiment showing the saw horse built into the tailgate of a vehicle.

FIG. 4 is an alternate embodiment of the embodiment shown in FIG. 3.

FIG. 5 is a second alternate embodiment of the embodiment shown in FIG. 3.

FIG. 6 is a third alternate embodiment of the embodiment shown in FIG. 3.

FIG. 7 is an alternate embodiment showing the receiver hitch used as a mounting surface.

FIG. 8 shows a modification to receiving scaffolding of the embodiment in FIG. 1.

FIG. 9 shows a modification to receiving scaffolding present on the embodiment shown in FIG. 1.

FIG. 10 is a detail view from the top of FIG. 9.

FIG. 11 is a detail view of the foot shown in FIG. 9.

### DETAILED DESCRIPTION OF THE PREFERRED EMBODIMENT

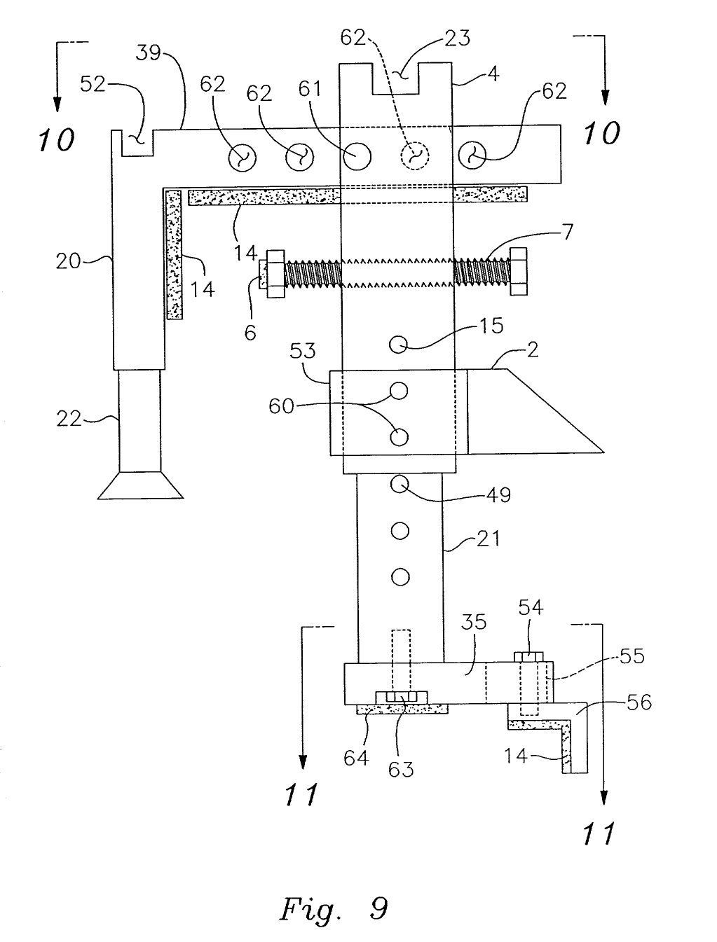

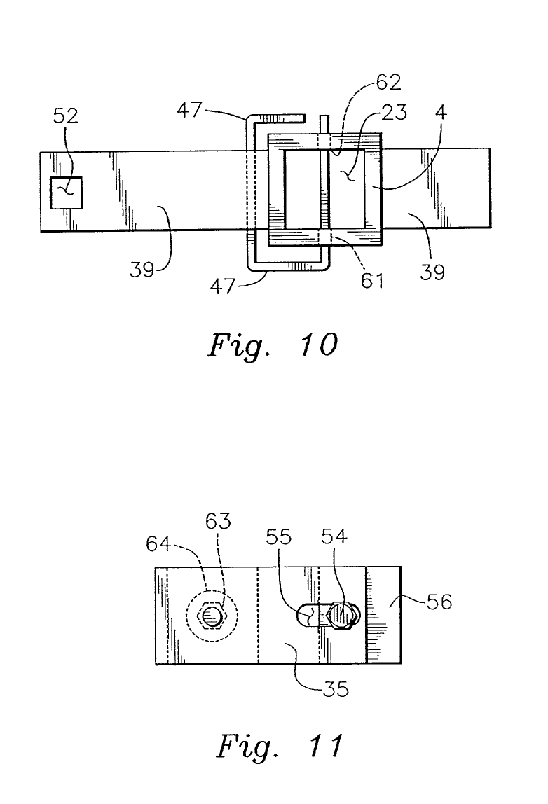

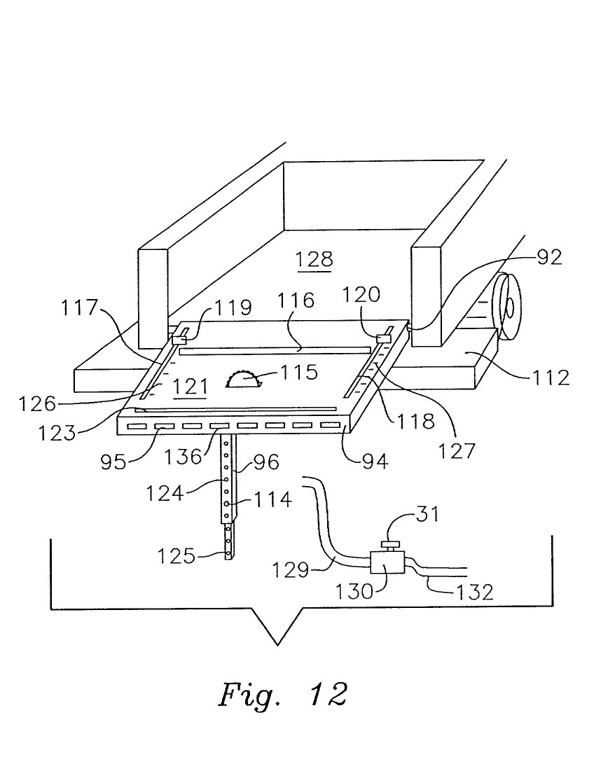

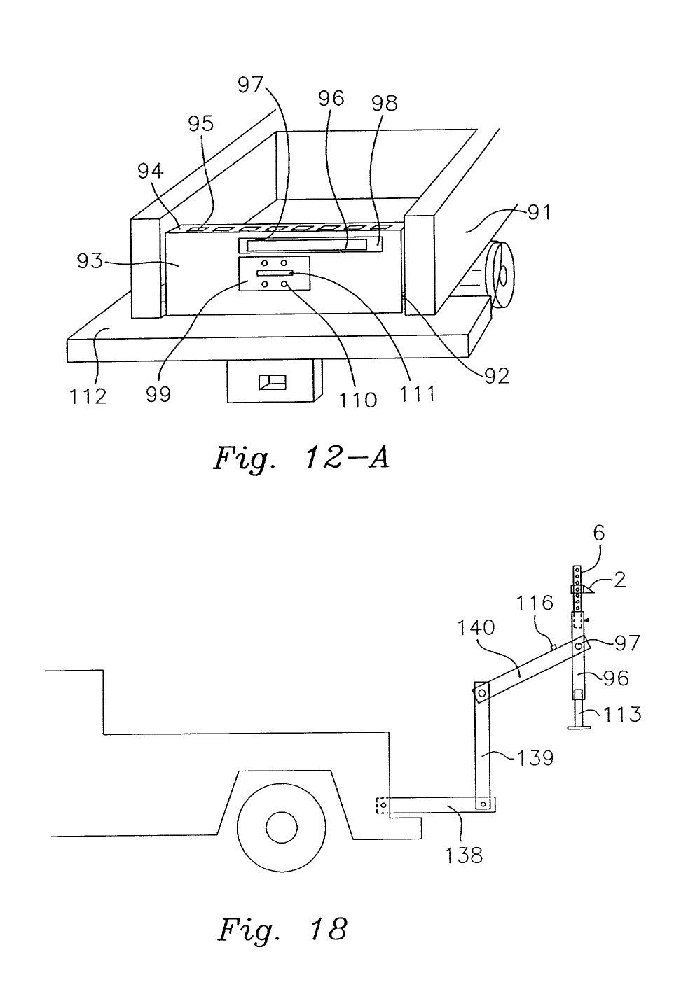

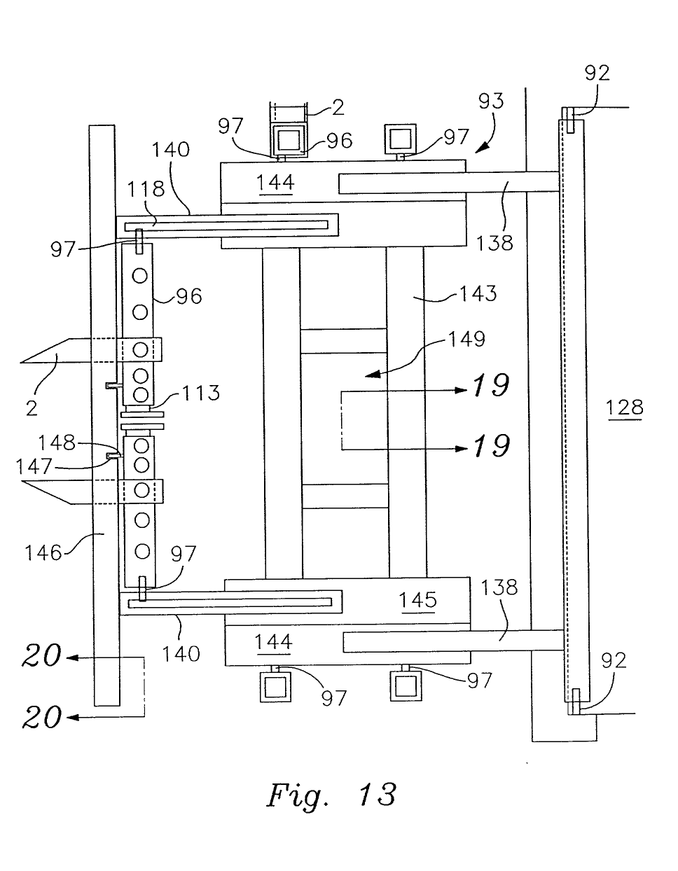

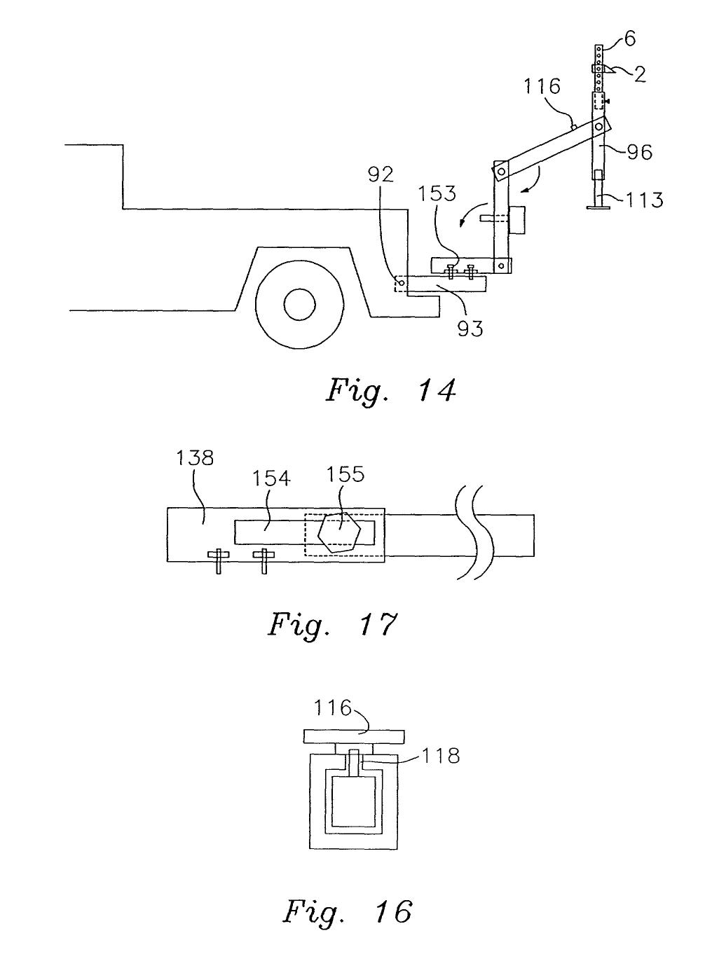

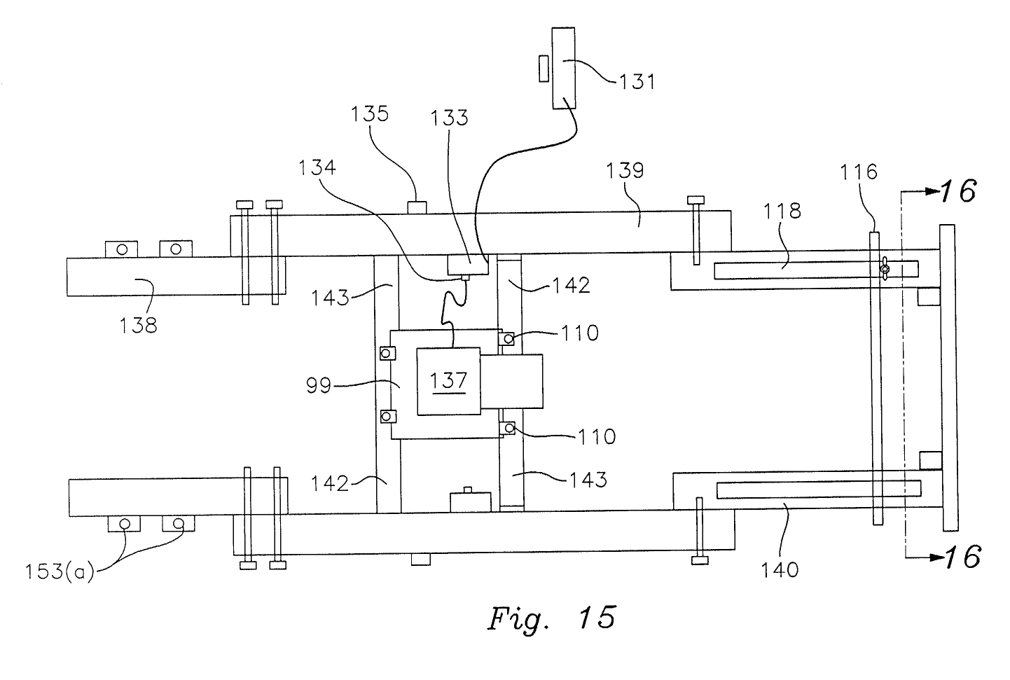

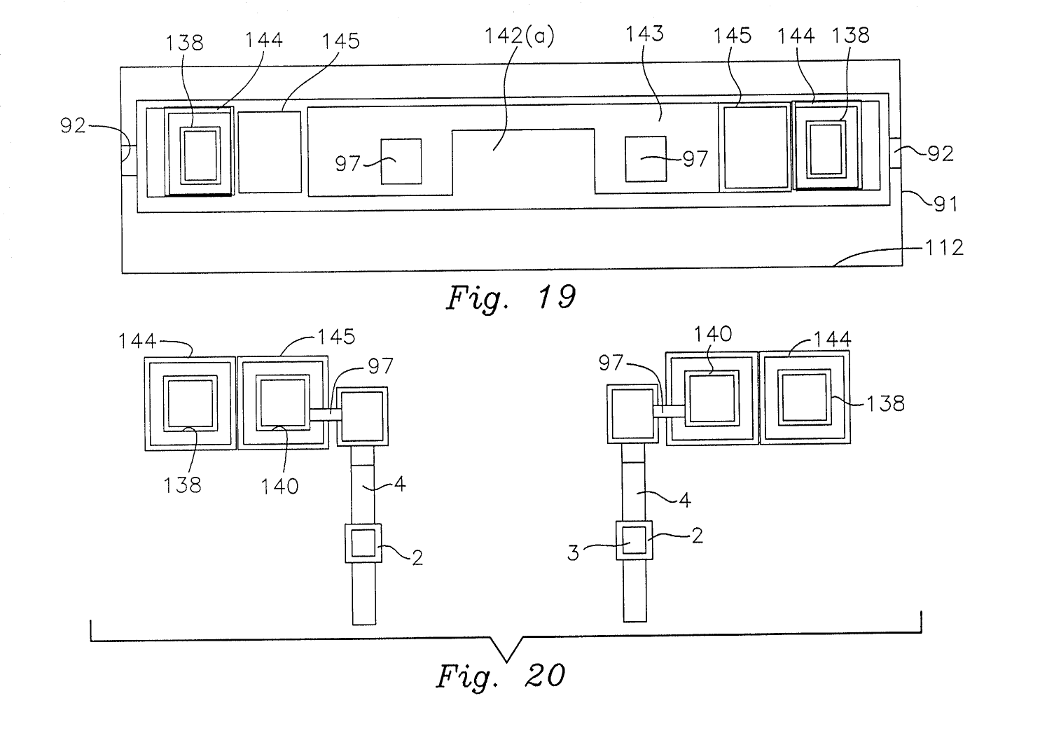

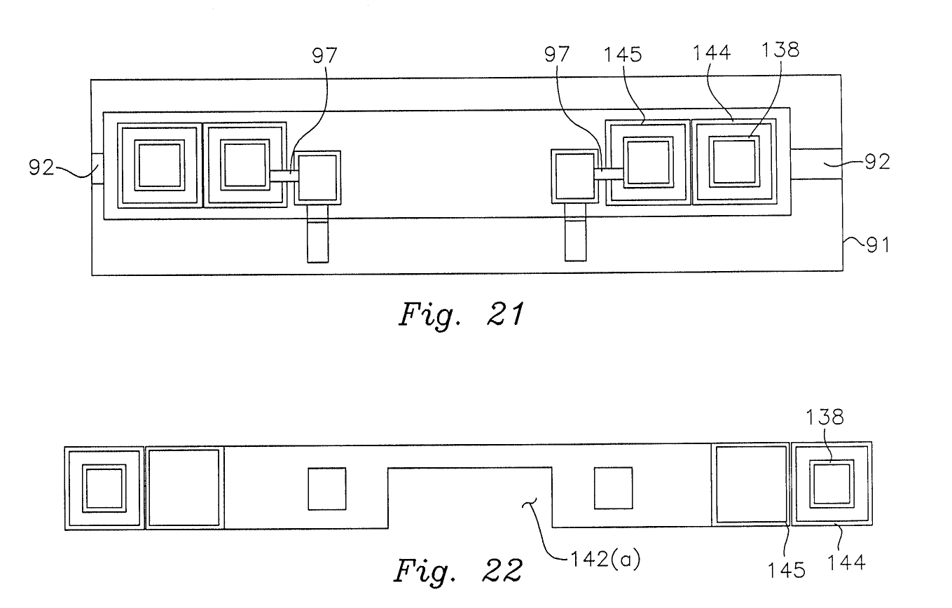

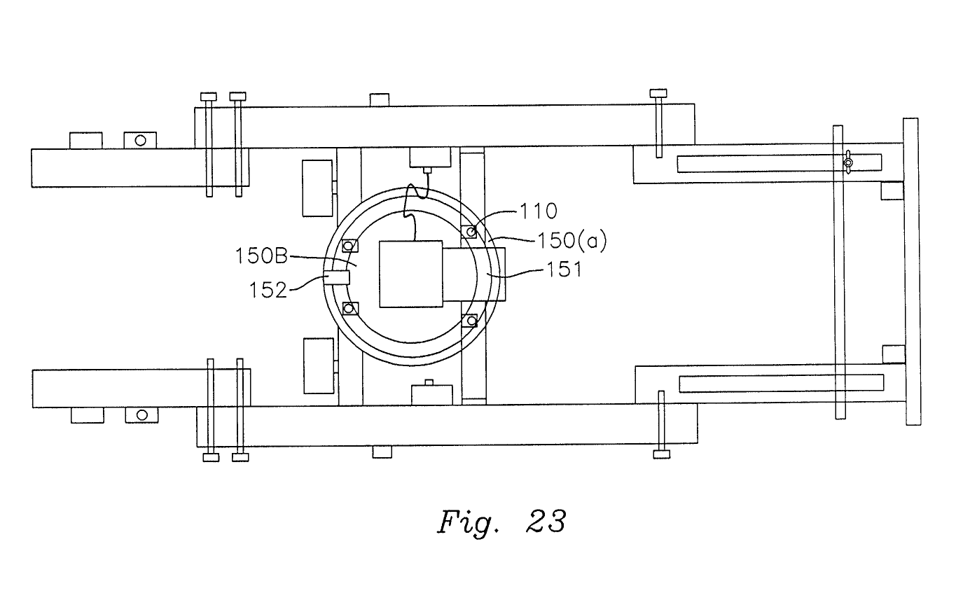

As can best be seen by reference to FIG. 9, the invention comprises a bracket means for holding a cutting surface wherein the cutting surface 1 is preferably a two by four and wherein the bracket means is preferably a bracket 2 held by a support means, here two legs, a first primary leg 4 and a secondary leg 20. These are connected by a top leg 39. In the embodiment shown in FIG. 9, each of the two bracket means comprises a primary leg 4, a secondary leg 20 and a top leg 39 which here, is a welded integral part of the secondary leg 20. Pads 14 may be provided to ease the contact between the legs and the vehicle tailgate (shown in FIG. 1). The primary leg 4 has primary leg holes 18 capable of receiving a straight or locking pin 47. An example of a locking pin is shown in FIG. 10. A primary leg extension 21 allows for the length of the primary leg 4 to be extended. The primary leg extension 21 fits within the primary leg 4 and has holes 49 which may also receive a locking pin 47 to fit the length of the extension 21. A base plate 35 has a L-clamp 56 attached to the base plate 35 which can hold the device to a vehicle bumper 9. The base plate 35 is secured to the primary leg extension 21 by a countersunk bolt 63 and may have a pad 64 over the base plate 35 to even out the height relative to the L-clamp 56.

A bolt 7 is used to vary the angle at which the primary leg 4 sits against the vehicle by moving the primary leg 4 away from the tailgate 11 as the bolt 7 is moved towards the tailgate 11. The primary leg 4 is threaded so that the bolt 7 may turn through the threading to push against the tailgate 11. At the end of bolt 7 is a pad 6 which serves to cushion the bolt 7 as it presses against the tailgate 11. A locking pin 47 (which may be replaced with a bolt as shown in FIG. 1) fits though the hole 60 in the c-clamp 53 which fits around the primary leg 4 and is secured to the bracket 2. The hole 18 is lined up with a primary leg hole 48 at the desired height. It could also attach to the secondary leg in other embodiments. A second lower pin 47 (or the same locking pin 47) is used to fix the position of the primary leg extension 21 by passing though one of the extension holes 49 and primary leg holes 18 in this embodiment.

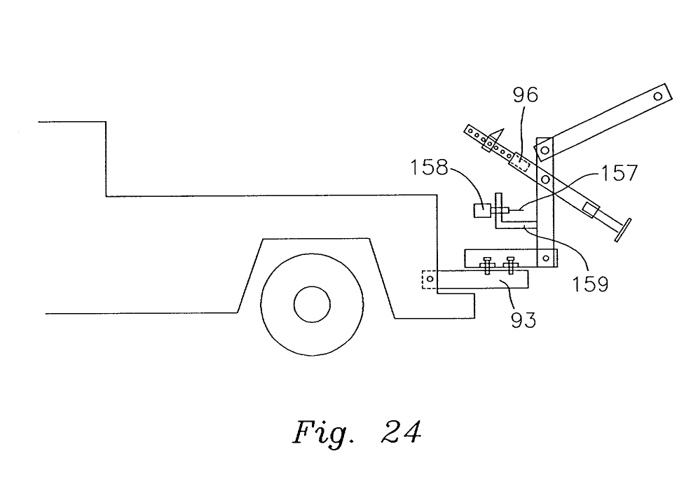

At the termination point of the extension is a base plate 35. As shown in FIG. 11, the base plate 35 defines a slot 55 which serves to receive a bolt 54 which moves within the slot 55 to position L-clamp 56 which secures of the primary leg to the bumper. The base plate may turn about pin 63 in either direction to secure from the front or rear of the bumper.

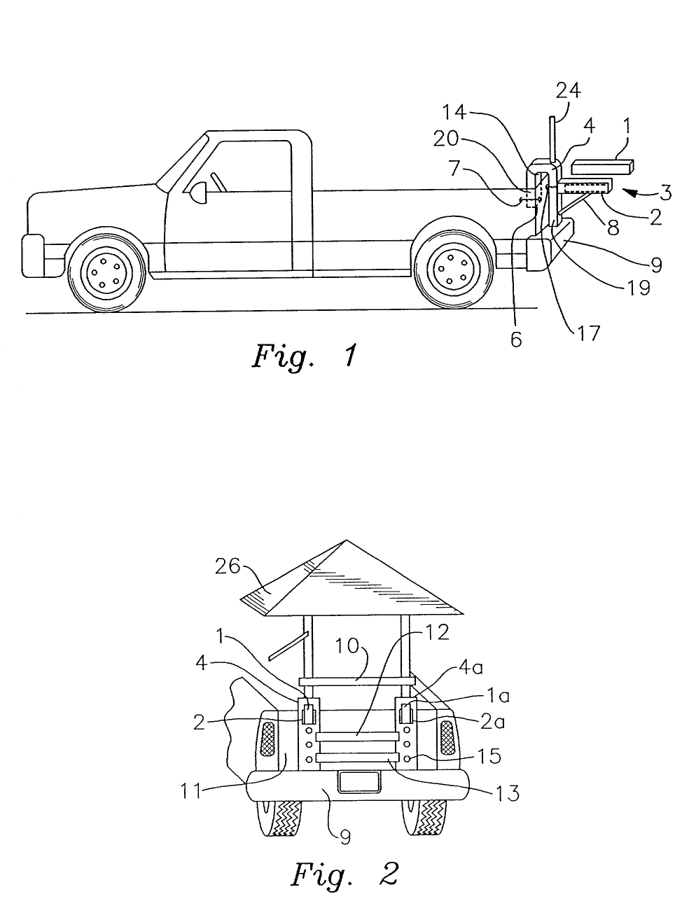

This shape allows the primary leg 19 to rest on the bumper 9 of the truck to which it is mounted. Secondary leg 20 lies on the opposite side of the truck tailgate 11 from the primary leg 19. Top leg 39 fits over the top of the tailgate 11 and through a hole in primary leg 4 to tighten the primary leg 9 and secondary leg 20 against the tailgate 11 as shown in FIG. 10. Secondary leg 20 need only be long enough to provide a surface to support the cane shaped structure thereby defined. Front scaffold hole 23 and rear scaffold hole 52 may be provided to receive scaffolding (shown as 24 in FIG. 1) as described in more detail in reference to FIG. 2.

The attached drawings show several different embodiments of the invention. In all cases it is envisioned that two separate cutting surfaces 1, preferably two by fours, will be held approximately parallel so that the combination forms a sawhorse type arrangement.

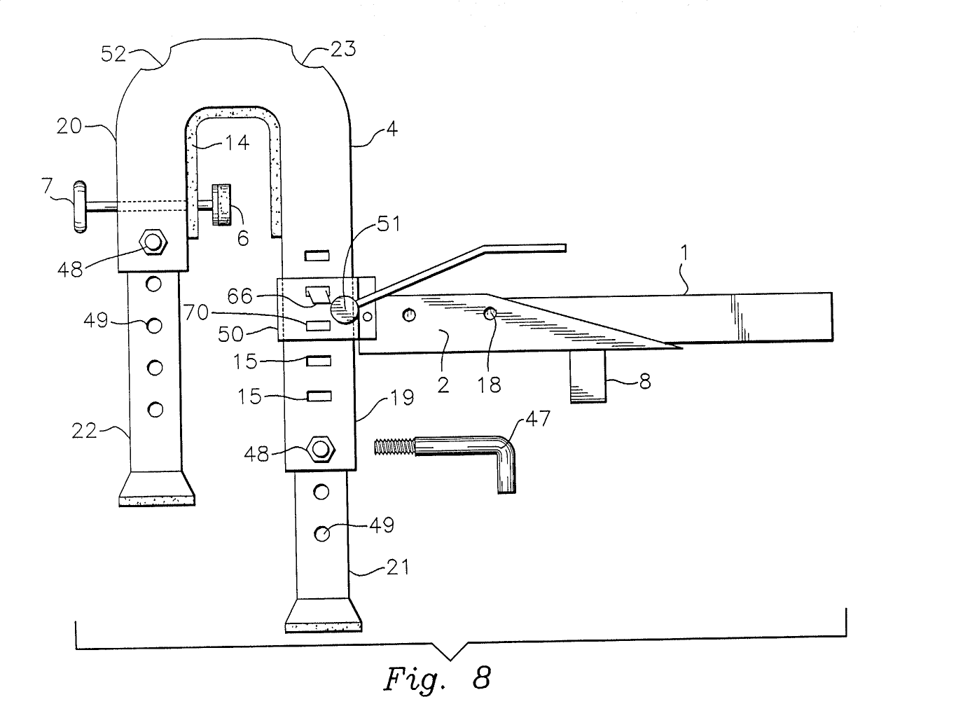

In its broadest embodiment, the invention is nothing more than a bracket 2 for holding a cutting surface 1 to an attachment surface, in the shown embodiments, a tailgate 11. It can easily be seen that the sawhorse in the various embodiments shown could mount to different locations on a vehicle, the main invention set out herein. However, by describing the specific structure (FIG. 8 and 9), it can be seen that this specific type of bracket may fit over boards parallel to the ground and held up by nails into the frame at a house being framed. This would be desirable where, for example, it was desired to build a roof over a frame or to have a sawhorse within a frame. To accomplish this, a board is nailed parallel to the ground on studs of the frame and then the sawhorses described herein are put onto the board, just as if a tailgate was being used.

The attachment means for holding the bracket 2 is described herein in several different embodiments. In FIG. 9 it is a c-clamp 53 fitting around a primary leg 4 where the c-clamp 53 is attached to the bracket 2 by a joining weld.

In FIG. 8, the c-clamp is replaced with a jack 50, such as that which is found on standard automobile jack. With a jack, the height of the bracket may be adjusted or the height of the bracket 2 adjusted even when fully loaded by using a leveraged arm 51. Here, a bolt 47 fits through a nut 48 to secure the position of the secondary leg 21 relative to the primary leg 4. The slots 15 shown in the primary leg 1 are engaged by jack 50.

Also, FIG. 8 shows an embodiment where the primary, top and secondary legs are a single unit. This would be preferred where only a single sized tailgate was used. Here, the adjusting bolt 7 with pad 6 is on the secondary leg as opposed to the primary leg. Padding 14 is also used in this embodiment.

The jack 50 might be replaced with other adjusting mechanisms. One example would be to have an adjusting bolt within the primary leg 4 which is rotated by a handle outside of the primary leg. The length of adjusting bolt would rotate and would run parallel and within the primary leg length. In this way, the bracket could be mounted to an adjusting nut which was 11 fitted onto this adjusting bolt. A the bolt was turned, the height of the bracket would vary as the nut holding the bracket moved up and down the bolt.

As can be seen, the bracket defines holes 18 through which a nail or screw may be driven to secure the cutting surface 1. The attachment surface shown in FIG. 1 is the tailgate 11 of a truck. Any similar surface would provide for a different embodiment, but is considered herein. For example, using a board nailed to a frame providing a similar surface for attaching the primary, top and secondary legs.

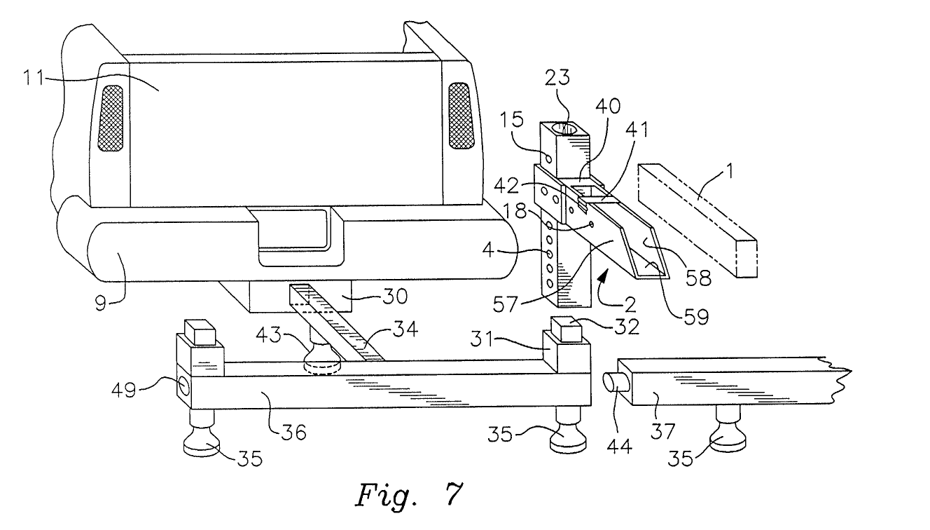

FIG. 7 shows the use of a receiver hitch 30 for receiving a receiver hitch beam 34 which in turn holds t-bar 36. Support beams 31 extends upward from the t-bar 36, supported from the ground on one or more base plates 35. The primary leg 4 then is attached to this support beam 31. Extension beams 37 supported by base plates 35 may be provided to lengthen the sawhorse spread between two or more primary legs 4. The extensions have extension pegs 44 which may fit into extension holes 49 to extend the length and add primary legs 4 and their corresponding brackets 2. As can be seen in FIG. 7, the bracket 2 has atop 40, a left side 57, right side 58 and bottom 59. The forward top portion of the left side 57 and right side 58 slant down toward the bottom 59 so that progressively more of the cutting surface 1 is exposed.

The bracket 2 has one or more holes 18 into which a bolt may be inserted to hold the board or other cutting surface 1 in place within the bracket 2. A hinged top 41 is also shown which would be an alternative or addition to the top member 40.

In all of the embodiments, it is envisioned that there would be two brackets 2, having longitudinal lengths which are parallel to one another, and separated by a distance of at least two feet (60 centimeters) so as to hold two boards out from the attachment surface tailgate 11 so that the two boards 1 function essentially like a saw horse. However, this distance, between cutting surfaces (boards) 1 could vary from no more than 6 inches (15 centimeters) outward.

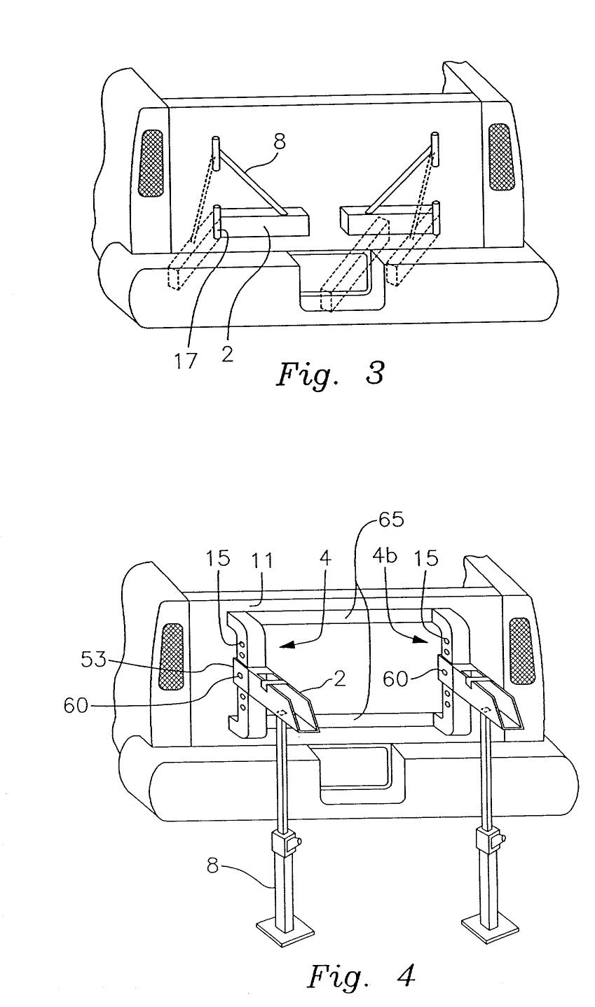

FIG. 1 shows one embodiment of the invention. The invention may described as a mounting means, here a primary support 4 which holds a bracket 2, here in the form of a length of channel iron having a longitudinal length. The channel iron bracket 2 defines a slot 3 into which a two-by-four or similar cutting surface 1 may be inserted. The channel iron is mounted on a cane-shaped support (like shown in FIG. 8) having a primary leg 4, a top leg 39 and a secondary leg 20 which here are molded together in a single cane-shaped support. The bracket 2 has a brace arm 8 which may rest on the bumper 9 of the pick up truck or against the support 4 or against the ground. The mounting of the bracket 2 to the support 4 may be by a weld or by a hinge so that it may swivel out as shown in FIGS. 3, 4 and 6. When a swivel is used, the support needs to swivel out at least 90 degrees in the preferred embodiment from the plan formed by the face of the tailgate 11.

While in FIG. 1 the secondary leg 20 merely hooks over the tailgate the secondary leg 20 may be long enough in order to reach the flat bed of the truck. As shown in FIG. 8, this could be done with a secondary leg extension 22.

The brace arm 8 may be made adjustable in length, so that it may brace the bracket 2. This brace arm may run from the bracket 2 to the primary leg 4 (as shown in FIG. 1), or it may run to the bumper 9, or it may run more or less straight down to the ground (as shown in FIG. 4), to support the rear of the bracket 2 against the ground. In FIG. 4, this brace arm 8 is shown going to the ground. It may also rest on a wheel to allow the sawhorse to move with the truck.

This brace arm 8 may either be fixed or may be hinged at the point of attachment to the bracket 2 as shown in FIG. 3 and FIG. 6. It may attached to one or alternatively at all three locations set forth above.

Since the beam 2 is desirable as a steady surface, some mechanism could be provided in order to hold the support 4 in place and to adjust the angle of this relative to the ground.

Several alternatives are present for this.

The simplest, would be to have a bolt 7 push a pad 6 against the tailgate of the truck to which the device is mounted as shown in FIG. 8 or to use the brace arm 8 to vary the angle.

To properly fit the support 4 to the tailgate the shape of the support may correspond more closely to the surface over which it fits, so that it tightly fits in place, either with or without a padding to enhance the fit. Also, the entire support top may be hinged so that the distance between the primary legs to the secondary legs can be tightened in order to draw the primary leg to the secondary leg, sandwiching the truck bed between the two (as shown in FIG. 9). Similarly the bracket 2 could be attached by way of hinges 17 allowing the angle between the tailgate and the bracket to change. To prevent undue damage to the truck in either embodiment, an inner pad 14 is envisioned to cushion places where the support 4 comes in contact with the truck and where the primary leg or secondary leg comes in contact with the truck or the bumper.

The invention is to be used as a saw horse. The brackets themselves must be made of a material which can be cut or they must provide a slot 3 or the equivalent of the slot 3, in order to mount a cuttable block 1 which is preferably a two-by-four or four-by-four, depending on the size of the sawhorse desired. The slot shown in FIG. 7 has a top 40, a left 57 and right 58 side and a bottom 59 which define the slot 3 into which the cutting surface 1 may fit. A hinged top 41 is 11 an optional part to better secure the cutting surface 1.

In the preferred embodiment, the slot 3 allows for an enclosed portion of a two-by-four cutting surface 1 of sufficient length to be slid within the slot 3. The remainder of the two-by-four extends out of the slot 3. The two-by-four may be tightened in place utilizing a screw-type mechanism so that the boards do not slip out of the grooves. Alternatively, the slots can have sufficiently small tolerances, so that the boards (cutting surface 1) are held tightly, or the boards may be held more loosely in these slots 3. As shown in FIG. 7, one or more holes 18 in the bracket 2 may be present in order to allow for the board to be secured by way of a screw or nail or bolt which fits through the holes 18 into or onto the board 1. FIG. 1 shows a slot which is only enclosed on three sides. As can be seen, these slots are to hold boards which are less than ten inches (25.4 cm) across, although they are preferably six inches (15.24 cm) or less and greater than one inch (2.54 cm).

As shown in FIG. 2, top band 12 and bottom band 13 may both be put in place in order to hold the a first primary leg 4 and a second primary leg 4a in place and to fix the distance from one bracket 2 to the next bracket 2a. While these supports are shown on the primary legs, they may also be mounted to the top leg 39 or to the brackets 2 and 2a.

These bands 12 and 13, may also allow for the length between them to be adjusted.

As shown in FIG. 2 a board 10 may be placed over the beams, once in place, in order to provide a table surface on which to work. In addition, the support 4 may define a scaffold hole 23 at the top into which a scaffold leg 24 may be inserted. The scaffolding provided may support various implements 25 using scaffolding and may support a shade 26 so that the work done is done out of direct sunlight. The combination of the cutting surface 1 and board 10 may be replaced with a table saw or drill or similar device. While this would be a significant departure from the inventive concept embodied herein, it is a possible use of the bracket system herein described.

As shown in FIG. 8, leg 4 or 20 may have an adjustable extension 21 and 22 respectively, in order to allow a single device to be mounted on trucks having tailgates of various sizes. This extension may be, as in the preferred embodiment, a leg of variable length, mounted to the bottom of either primary leg 19 or secondary leg 20.

The primary leg 4 defines a height adjustment means for varying the height of the bracket. In the preferred embodiment this adjustment means comprises a series of holes. The bracket 2 is held in place in the embodiment shown in FIG. 1 with a bolt 17. However, any height adjustment means such as a screw, hydraulic jack, mechanical jack or the like may be substituted. In one concept the bracket could be mounted to a nut which traveled on a threaded bolt which could rotate within the primary support. As the nut travels up and down this bolt, the position of the bracket changes.

There are a number of alternate methods of mounting the beam to the primary leg which would include a permanent welding of the beam in place, the placement of the beam along the set of tracks (such as those used in shelving or specialized tracks for this particular use). Similarly, it could be secured at two or more points by three or more bolts 17 or the equivalent thereof.

Alternatively, once the height was determined for a particular set or a particular vehicle, it could then be either welded in place or even glued in place with the proper technology.

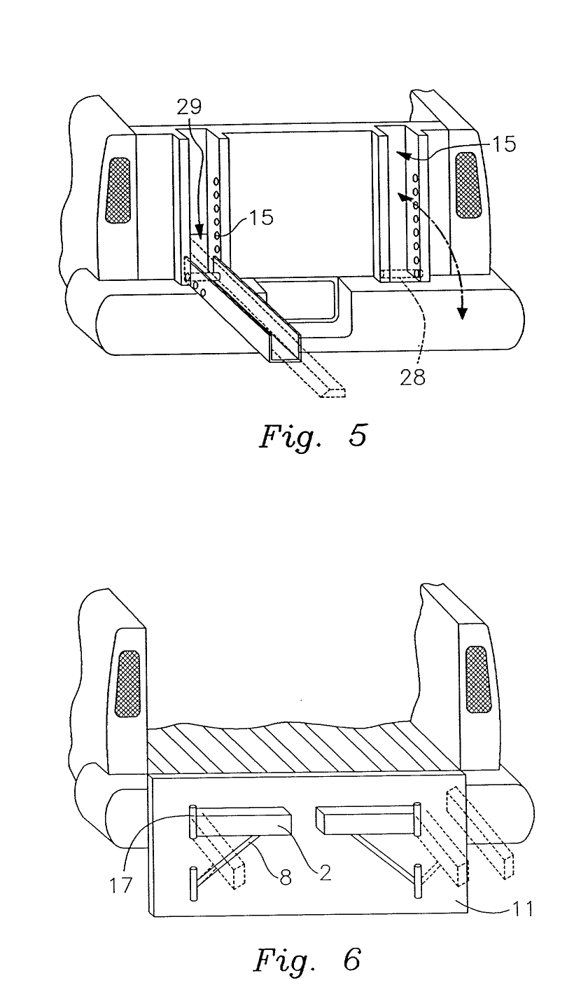

Similarly, there could be a groove defined along the length of the primary leg 19 and a securing mechanism would provide that the bolt could slide within that groove, and then be wide enough or have a washer which was wide enough to prevent it from moving completely out of the slots which would provide for a greater degree of adjustment as shown for the base plate 35 in FIG. 11.

Where an embodiment such as that shown in FIGS. 3-6 is used, it would be preferable to have the height of the pivot 28 changeable along the truck tailgate as by having rails (FIG. 5) serving as primary supports 4 along which pivots or brackets move on c-clamps 53 fitting around the rail type primary supports 4.

Once two of the supports and brackets are in place, and boards are placed within the slots in the beams and a saw horse or work surface is provided. As described in the invention, it can be seen that although these beams could be uneven; in the preferred embodiment, they would be at the same level so as to provide an approximately flat cutting surface.

A level could be utilized in order to assure that they provided a flat surface or where the ground where the user stood was uneven, the height could be adjusted in order to provide a surface consistent with the perspective of the user. The distance from the ground should vary in order to provide an acceptable height from which to work.

FIGS. 3, 4, 5 and 6 show methods of modifying the tailgate itself to act as the support 4 for the bracket 2 and brace 8. As shown in FIG. 5, the tailgate itself may provide recesses 15 into which the bracket 2 fit when not in use. As shown in FIG. 5, the brackets may be mounted on pivots 28 adjustable on support holes is so that they may swing out into place to receive a cutting surface 1, here a board.

A tailgate opening 29 is shown through which the board 1 can slide onto the truck bed and the truck bed and tailgate opening 29 function as a bracket. As shown in FIG. 4, the brace 8 may be located below the bracket 2 and run to the ground so as not to interfere with the cutting area.

In FIG. 4 the brackets 2 mounted on c-clamps 53 slide over primary supports 4 and 46, fitted through holes 15 and 60. The primary supports 4 and 46 slide within rails 65 built into the tailgate 11. FIG. 5 shows where the brace may drop down vertically so that the bumper 9 provides the brace 8 for the bracket 2. FIG. 5 shows holes 18 to secure the cutting surface 1 in the bracket slot 3. In addition, there is a tailgate opening 29 through the tail gate 11 which allows the cutting surface 1 to be moved in and out of the trailer bed when the bracket 2 is lowered. This tailgate opening 29 may also hold a portion of the cutting surface 1 so that it does not fall downward when pushed down at the far end from the bracket 2. When the bracket 2 is folded into the tail gate 11, the tailgate openings 29 are shut off.

While the invention is primarily designed for use with a vehicle having a tailgate 11, it can be seen that the attachment surface shown as the tailgate 11 could easily be the side panel or front panel of the vehicle.

In order to lower the level of the cutting surface further, FIG. 6 shows how a tail gate may have the cutting surface on the inside face. In this embodiment, the tail gate would have to be constructed so as to fold down below the bumper. This could be done by modifying the construction of the bumper or by adding a second tailgate containing the invention behind the primary tailgate so that this mechanism would function properly.

Yet another example of how this may be practiced, shown in FIG. 7 allows for the bracket means to be mounted onto the receiver hitch 30. Here the bracket is brought out onto an extended system supports holding primary supports for larger projects using the vehicle as a ready anchor. A similar hitch mounted to the front of the vehicle could also be used. In FIG. 7, the tailgate is not affected. Instead the bracket 2 is mounted by way of the receiver hitch 30 below the bumper. The primary support 4 is mounted on a support beam 31 by way of a joining means which here comprises a hole 33 in the bottom of the support 4 into which a post 32 in the support beam 31 is inserted. The support beam 31 has a support foot 35 much like the brace arm 8. The support beam is attached to a receiver hitch beam 34 by way of a t-bar 36. This provides for greater spacing between the two brackets 2. The length of the t bar, and the ability to provide for more brackets 2 is provided by having extension beams 37 which may have beam posts 39 which may be inserted into beam holes 38 in the t bar 36 or in other extension beams to form a matrix of support beams and corresponding brackets 2. Since these support beams 21 may have scaffolding holes 23, a matrix for scaffolding is also provided.

As shown in FIG. 7, the bracket is modified so as to have a top portion which may be sealed at the rear with a roof 40, or a hinge 41 holding a cap 42 over the top of the rear portion of the slot 3 in bracket 2 so as to better secure the cutting surface 1.

There is a receiver hitch beam foot 43 which can be used to keep the sawhorse brackets 2 in place after the vehicle is used. There may also be extension feet 44 to support the extensions 37 which may be used to extend the length of the t-bar 36. The t-bar 36 as shown runs in either direction from the receiver hitch beam 34. It is obvious, however, that it may run in only one direction from the receiver hitch, either left, right or back. The only requirement is that either the receiver hitch beam 34 itself or the t-bar 36 hold at least two supports 4 so that a saw horse arrangement is possible.

FIG. 8 shows a close up of an alternative support/bracket arrangement shown in FIG. 1. In FIG. 8, at various locations, the holes 15 and 60 are rectangular and corresponding latches 60 are attached to the side (although they could be on the back or bottom) of the bracket 2 so that the beam latches 60 use the side of the brackets 2 and the weight of the brackets 2 to hold the bracket latched in place. Traditional car jacks function in this same fashion. Any jack-type arrangement, such as a hydraulic jack or a car-type jack could be utilized in order to raise and lower the height of the beam 2 so as to provide greater adjustment and to allow the level of the beams to be moved without effort when loaded. A bolt 47 through a nut 48 in the primary leg 19 and secondary leg 20 pass into holes 49 in the extensions 21 and 22 to adjust the height. A jack 50 is used to adjust the height as with a standard jack used on an automobile using a jack arm 51. A secondary scaffold hole 52 is available to allow square scaffolds to be erected in conjunction with scaffold hold 23.

All of the embodiments shown hold the cutting surface of the board at approximately 90 degrees to the face plane of the tailgate 11. However, a lesser angle might be utilized and still accomplish the desired result. This angle would preferably be for 30 degrees to 90 degrees. Similarly a single bracket might be used instead of two as long as a space for cutting was formed, although this would result in a significantly different invention. In the present embodiments, the ability to alter the spacing of the two cutting surfaces is a significant improvement.

In one embodiment, there would be a rack folded into the tailgate which would drop so that one part was parallel to the bumper. The second part would drop down past the bumper and perpendicular to the bumper to the ground, and a third part, which would be adjustable in height, would be the bracket, which could be raised and lowered relative to the part went to the ground from the tailgate. Each of the parts coming off of the tailgate could be made in such a way that they folded within the other part and dropped out in a hinge-type mechanism.

Because many varying and different embodiments may be made within the scope of the inventive concept herein taught and because many modifications may be made in the embodiment(s) herein detailed in accordance with the descriptive requirements of the law, it is to be understood that the details herein are to be interpreted as illustrative and not in a limiting sense.

I claim:

1. A device for holding a cuttable item to be worked on and for mounting a tool having a blade and for supporting the cuttable item said device being attachable to a vehicle resting on the ground, said vehicle having a vehicle frame having a left panel and right panel with a top and bottom comprising:
(1) a central frame having a left side and a right side, a top and a bottom and inside and outside defining a central frame opening, said central frame inside defining a frame surface for holding material and said central frame further defining a tool holding means for holding the tool.

2. The device of claim 1 wherein the central frame is rotationally attached at the left side and right side to the vehicle between the left panel and right panel so it may be lowered with the outside facing the ground.

3. The device of claim 2 wherein the central frame is rotationally attached to the bottom of the left panel and right panel.

4. The device of claim 3 wherein the central frame further comprises angle means for adjusting the angle at which the frame surface is suspended above the ground.

5. The device of claim 4 wherein the angle means comprises a bumper below the left and right panel so that the bumper supports the central frame when it is rotated.

6. The device of claim 4 wherein the tool further comprises a motor and wherein the central frame comprises on the outside a holding means for holding the motor on outside.

7. The device of claim 6 wherein the central frame defines a blade opening for allowing the blade of the tool to extend through the central frame approximately perpendicularly to the frame surface.

8. The device of claim 1 wherein the central frame comprises a first portion attached to the surface of the vehicle, and at least one second portion extendably attached to the first portion so that the length of the frame surface may be extended.

9. The invention of claim 8 further comprising a locking means for fixing the position of the first portion with the at least one second portion.

10. The invention of claim 8 wherein the first portion defines slots and wherein the at least one second portion defines legs which are extendable from within the first portion slots.

11. The invention of claim 8 wherein the at least one second portion is attached to the first portion by way of pivots so that the second portion may fold out at the pivots from the first portion.

12. The invention of claim 8 wherein the vehicles is comprised of panels, including a replaceable panel and wherein the device attaches in place of the replaceable panel of the vehicle and wherein the device is approximately the same size as the replaceable replaced when the at least one second portion is not extended.

13. The invention of claim 12 wherein the replaceable panel is the tailgate.

14. The invention of claim 8 wherein the invention comprises at least one third portion extendably attached to the at least one second portion.

15. The invention of claim 1 wherein the central frame further comprises a first measuring means for holding a cutting piece in contact with the blade in a desired location along the length of the cutting piece and to hold the cuttable item square to the blade.

16. The invention of claim 15 wherein the first measuring means comprises a ruled means showing the distance between the part of the blade to be cut.

17. The invention of claim 16 further comprising at least one alignment bar slidably connected to the frame surface and a ruled scale between the squaring means and the blade.

18. The invention of claim 17 wherein the alignment means further comprises at least one second alignment bar connected to the frame surface at an alignment angle to the at least one first alignment bar.

19. The invention of claim 18 wherein the alignment angle is adjustable.

20. The device of claim 1 wherein the mounting means further comprises a leveling means to allow the central frame to be leveled with the ground opening leveling means—up and down left and right.

21. The device of claim 20 wherein the leveling means further comprising at least one leg for support one saw table central frame attached to the central frame.

22. The device of claim 21 wherein the at least one leg is of variable length.

23. The device of claim 20 wherein the central frame defines at least one gap within the outside and wherein the at least one leg is pivotally attached to the central frame so that the at least one leg can fold into the at least one gap formed by central frame.

24. The device of claim 20 wherein the at least one leg further comprises a device for holding a first cutting surface defining an enclosed portion and an exposed portion, and said device also for holding a second cutting surface defining an enclosed portion and an exposed portion, each of said first and second cutting surfaces having a top surface, a length and a width with said first and second cutting surface being held by said device so that the first and second cutting surface are approximately parallel and above a standing surface, said device comprising:
(A) a first bracket means defining a first slot for receiving the first cutting surface enclosed portion so that the first cutting surface exposed portion extends outward and away from the vehicle interior and a second slot for receiving the second cutting surface enclosed portion so that the second cutting surface exposed portion extends outward and away from the vehicle interior approximately parallel to, but separated from said first cutting surface, said bracket means being attachable to said attachment surface.

25. The invention of claim 24 wherein at least one of the first cutting surface further comprises a wooden board having a top surface and an enclosed portion fitting within the slot and wherein the exposed portion further comprises at least a part of the board top surface.

26. The device of claim 24 wherein the height of the first bracket means is adjustable.

27. The device of claim 1 wherein the tool is from the group comprised of a saw, a drill, a welder or a torch and wherein the blade is from the group of a saw blade, a drill bit, a welding bit or a flame leveling means to hold parallel to the ground.

28. The device of claim 1 wherein the tool holding means rotationally holds the tool so that the tool may rotate relative to frame surface.

29. The device of claim 1 further comprising a power source having a switching means attached to the central frame for allowing a user to provide and remove power to a tool held by the tool holding means.

30. A device attachable to a vehicle having an interior and an exterior, said vehicle exterior defining an attachment surface, said device for holding a first cutting surface defining an enclosed portion and an exposed portion, and said device also for holding a second cutting surface defining an enclosed portion and an exposed portion, each of said first and second cutting surfaces having a top surface, a length and a width with said first and second cutting surface being held by said device so that the first and second cutting surface are approximately parallel and above a standing surface, said device comprising:
a) a central frame defining an opening for receiving a saw attached to the attachment surface;
b) a holding means for holding the saw within the space;
c) at least one leg comprising:
(I) a first bracket means defining a first slot for receiving the first cutting surface enclosed portion so that the first cutting surface exposed portion extends outward and away from the at least one central frame and a second slot for receiving the second cutting surface enclosed portion so that the second cutting surface exposed portion extends outward and away from the central frame approximately parallel to, but separated from said first cutting surface, said bracket means being attachable to said attachment surface.

31. A method for providing a cutting surface attached to a vehicle having an interior and an exterior wall comprising the steps of:
a) Attaching a first cutting surface, having an exposed surface to the exterior wall of the vehicle so that the cutting surface exposed surface extends away from the vehicle interior;
b) Attaching a second cutting surface, having an exposed surface to the exterior wall of the vehicle so that the cutting surface exposed surface extends away from the vehicle interior parallel to the first cutting surface.
